(19) United States
(12) Patent Application Publication
(10) Pub. No.: US 2020/0153602 A1
(43) Pub. Date: May 14, 2020

(54) SYSTEM FOR SYNCRHONIZING HAPTIC ACTUATORS WITH DISPLAYED CONTENT

(71) Applicant: Satyajit Siddharay Kamat, Bangalore (IN)

(72) Inventor: Satyajit Siddharay Kamat, Bangalore (IN)

(21) Appl. No.: 16/728,680

(22) Filed: Dec. 27, 2019

(51) Int. Cl. H04L 7/027; G08B 6/00

(52) U.S. Cl. CPC H04L 7/027; G08B 6/00

(57) ABSTRACT

Various systems and methods for synchronizing haptic actuators with displayed content are described herein. A system may include a computer system, a head-mounted display (HMD) system, and a number of actuators on a wearable device. The computer system may construct a data packet with a network address of a control mechanism on the wearable device and transmit the data packet to the HMD in a video/audio stream. The HMD may identify the data packet in the video/audio stream and forward the data packet to a bus. The control mechanism on the bus is able to retrieve the data packet and access a control message in the data packet, which is used to initiate an effect produced by the control mechanism. The control mechanism may be a haptics actuator, a light controller, or the like.

### TECHNICAL FIELD

Embodiments described herein generally relate to haptic systems and in particular, to a system that synchronizes haptic actuators with displayed content.

### BACKGROUND

Virtual reality (VR) is becoming increasingly popular. People may use VR for a variety of uses. A few examples include gaming, educational coursework, relaxation, or military training. VR includes visual and auditory stimulation. In some cases, the use of haptics (touch and feel) in VR is useful to more fully immerse the user into the virtual world.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a system that provides synchronization of haptic actuators with displayed content, according to an embodiment;

FIG. 2 illustrates two packet frame structures, according to an embodiment;

FIG. 3 is a block diagram illustrating a haptics multiplexer and formatter, according to an embodiment;

FIG. 4 is a block diagram illustrating a head-mounted display (HMD), according to an embodiment;

FIG. 5 is a block diagram of a haptics actuator, according to an embodiment;

FIG. 6 is a flowchart illustrating a method of synchronizing haptic actuators with displayed content, according to an embodiment; and

FIG. 7 is a block diagram illustrating an example machine upon which any one or more of the techniques (e.g., methodologies) discussed herein may perform, according to an example embodiment.

### DETAILED DESCRIPTION

Systems and methods described herein provide a system that synchronizes haptic actuators with displayed content. A haptic actuator includes a motor and a driver that may be integrated with wearable clothing and other devices to provide a sense of touch, vibration, or motion to a user (wearer). Haptics may be used to more fully immerse a person in a virtual reality (VR) environment. With a large number of haptic actuators distributed over some or all of a person's body, the person may experience a fully immersive virtual environment. Haptics may be used to provide touch sensations that are synchronized (e.g., coincide) with sight and sound in a virtual experience. The realism of the virtual reality may be improved by synchronizing the haptic actuators with the video content. Presently, haptic actuators are driven by custom interfaces that are unique to each VR system, where each VR system may be provided by different vendors. The pre-existing systems are limited by the interfaces available. They are not able to scale to a large enough number of haptic actuators to provide a fully immersive experience. What is needed is a system and method to synchronize large numbers of haptic actuators with displayed content.

This present disclosure describes a complete end-to-end system and method for synchronizing haptics feedback with video frame content using a control message, which may be used to drive any number of haptics actuators on a haptics suit using existing hardware connections like High-Definition Multimedia Interface (HDMI), DisplayPort (DP), or Universal Serial Bus (USB) Type C in Alternate DP mode, between compute and head-mounted display (HMD) with existing software drivers. It is understood that the control messaging may be extended to light controllers, such that lights that are on a wearable device may be synchronized with video frame content.

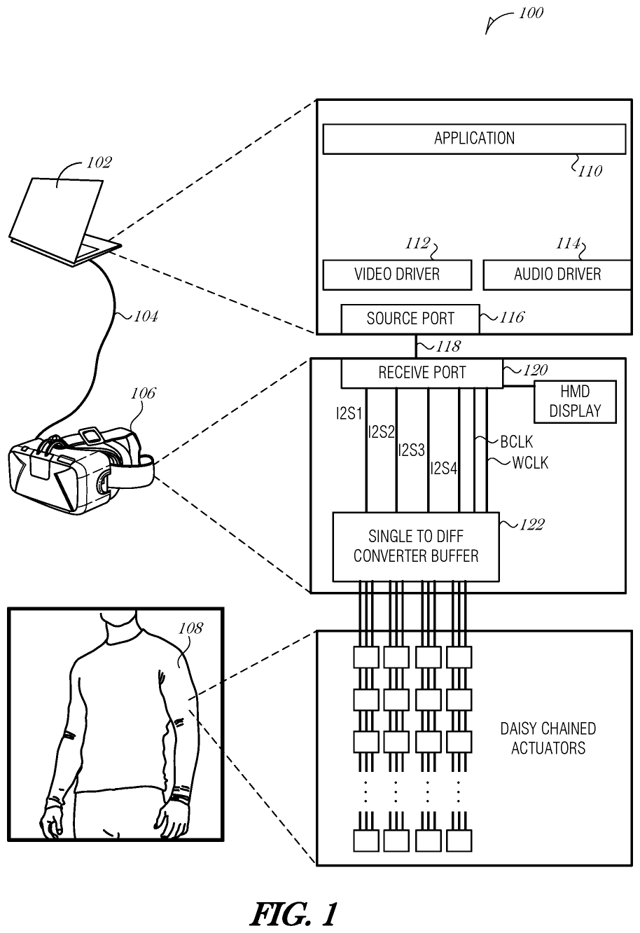

FIG. 1 is a block diagram illustrating a system 100 that provides synchronization of haptic actuators with displayed content, according to an embodiment. The system 100 includes a compute system 102 that is connected with a hardwired connection 104 to a head-mounted display (HMD) 106. The HMD 106 is connected to a wearable device 108 that includes haptic actuators. The wearable device 108 may be of any type including a shirt, body suit, hat, shoes, vest, watch, gloves, shorts, or the like. HMD 106 may be in the form of goggles, glasses, visor, helmet, or the like.

The compute system 102 may be of any type including but not limited to a laptop, hybrid computer, tablet, gaming system, phablet, smartphone, mobile device, television, desktop computer, or the like. The compute system 102 executes software to provide a VR experience to a user of the HMD 106 and wearable device 108. The VR experience may be of any type, such as a game, occupational training suite, work or productivity applications, real estate walkthroughs, home design, sports, movies and entertainment, or the like. When placed in the VR experience, the user may move around and interact with virtual object in a virtual environment. When interacting with these virtual objects, the haptic actuators built into wearable device 108, such as gloves, vests, bodysuits, boots, or other wearable elements are used to provide haptic feedback, such as force feedback and tactile experiences. This more fully immerses the user into the virtual world, especially when combined with visual and audio experiences.

The compute system 102 includes software and hardware components, such as application 110, video driver 112, and audio driver 114. The application 110 may provide signals, instructions, messages, or other control data to the video display driver 112 or audio driver 114 to output video or audio signals. The application 110 may also provide haptic signals based on collisions between the user and virtual objects as experienced in the virtual reality. The haptic signals may be formatted using a data packet structure.

The application 110 may read a configuration of the wearable device 108. The configuration of the wearable device 108 may include predefined addresses of each haptic actuator present on the wearable device 108, along with an association of the haptic actuator address and a location of the haptic actuator on the wearable device 108. The configuration may be created, altered, or otherwise managed by a user, administrator, application designer, or other person.

During launch of a VR application, virtual physics objects in a virtual human body matching actual haptic actuator positions are created and assigned. During application execution, haptics data is continuously generated for various physics objects in response to user interactions. Treating the haptics actuators as in-application physics objects simplifies collision detection algorithms. Additionally, treating the actuators as in-application objects improves the ability of the system to generate haptics data in real-time and synchronize the haptics data with the rendered video frame.

To improve synchronization of haptics feedback with audio and visual information, a haptics packet formatter is used to collate data for all actuators into an audio frame buffer. In an example, packet structure for each haptics frame comprises a preamble (e.g., for clock recovery if clock-less operation is desired), actuator address (e.g., position on suit), haptics effect command code, effect intensity, and time duration.

The packet frame structure maybe generalized so that it may carry alternative types of information or multiple types of information, such as a lighting commands or a combination of haptic information with other information or commands. For instance, the packet frame structure may be used to carry lighting effects information to illuminate one or more light emitting diodes (LEDs) on a wearable device. In the general case then, the audio and visual information is synchronized with activation of a control mechanism, where the control mechanism may be a haptics actuator (e.g., controller, driver, and motor), a light controller, or other type of output controller.

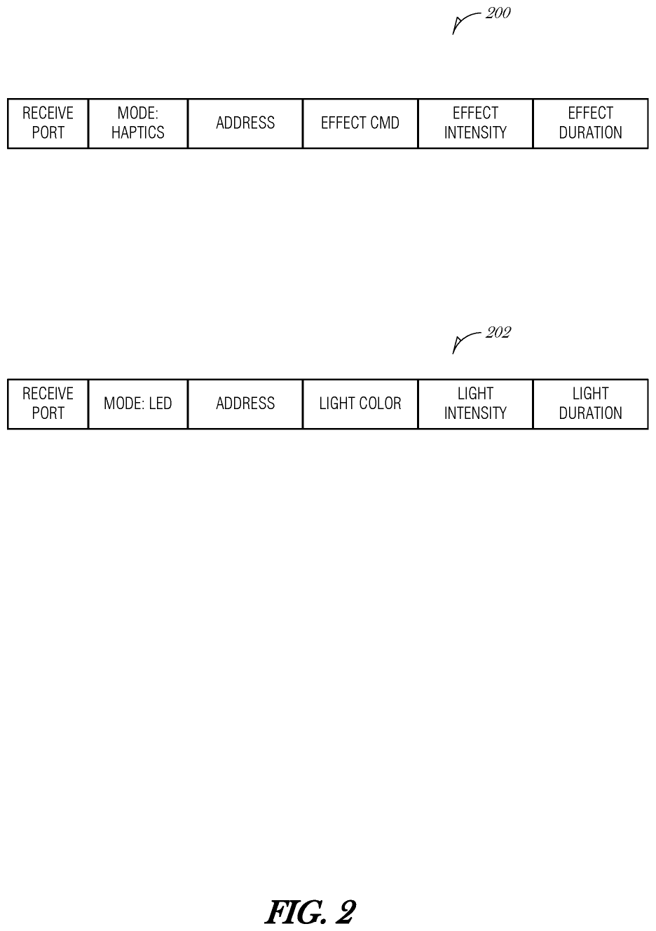

FIG. 2 illustrates two packet frame structures, according to an embodiment. It is understood that other packet structures may be used. As shown in FIG. 2, a haptics frame 200 includes a receive port preamble, a mode flag, an actuator address field, an effect command field, an effect intensity field, and an effect duration field.

The mode flag is used to indicate the type of packet frame. Modes may be “haptic” or “LED”. The mode flag may be one bit for the binary selection, however it may be increased in field size to accommodate additional modes.

The actuator address field stores a unique address for each actuator. This allows the actuators to be individually addressed for a high-definition tactile experience. Actuators may be grouped and be provided a common group address. In such a configuration, all actuators with the same common group address may use the same effect command, intensity, and duration variables. This common group address may provide feedback to multiple actuators in a body region, such as providing haptic feedback in an upper arm of a user.

The effect command field stores a code to indicate which haptics effect to produce at the actuator. Depending on the number of different types of effects available, the field may be relatively small (e.g., two bits to support four effects) or relatively large (e.g., six bits to support sixty-four effects). Effects may include clicks, ramps, buzzes, pulses, or the like. Effects may include a combination of patterns of one of more clicks, ramps, buzzes, pulses, or the like.

The effect intensity field stores a code to indicate how intense to produce the haptic effect. This may include a range between minimum and maximum values, such as 1-16 or some other range. The minimum and maximum haptic effect values may correspond with minimum and maximum magnitude of haptic effects that may be produced by the particular haptic actuator. The effect intensity field may be used to indicate a constant or decaying effect. In various examples, the effect intensity field may be used to indicate a constant effect such as an ongoing vibration, or may be used to indicate a decaying effect, such as an explosion vibration that decays over the next few seconds.

The effect duration field stores a code to indicate how long the haptics effect is to be produced by the actuator. The duration may be stored as a number of milliseconds to produce the haptic effect. The effect duration field may be used to indicate an effect is to be sustained over a given period of time. The effect duration field may be used to indicate a priority, such as to indicate an effect is to be sustained briefly until a new effect occurs.

As also shown in FIG. 2, an LED frame 202 includes a preamble, a mode flag, an actuator address field, an LED color field, an LED color intensity field, and an LED color duration field. Similar to the haptics frame 200, the LED frame 202 may be used to drive LEDs on a wearable device.

Returning to FIG. 1, the video and audio data are combined in the source port 116 in the compute system 102. For example, each haptic control event may be synchronized with and packetized within an audio frame. This provides the synchronization of each haptic event with the video data and audio data using underlying protocols. The receiving device (e.g., HMD 106) extracts the haptics data from the audio frame and uses it to drive haptic actuators.

The source port 116 may be a HDMI port, a DP port, a USB type C port, or the like. A cable 118 (e.g., hardwired connection 104) is used to connect the compute system 102 to the HMD 106. The HMD 106 includes a receive port 120, which may be of the same type as the source port 116 but is not required. For instance, the source port 116 may be an HDMI port and the receive port 120 may be a DP port with the cable 118 being an HDMI-to-DP cable. Other combinations of source and receive ports are included in the scope of this disclosure, such as USB-C to HDMI or DP to USB-C, for instance.

The HMD 106 receives video and audio data and may use it to present synchronized video and sound to the user via the HMD 106. Additionally, some or all of the audio frames are extracted and output over multiple channels. This may be performed using a single to differential converter and buffer 122. The channels may be Inter-IC Sound (I2S) bus lines. In an embodiment, all channels of a 7.1 audio signal are split up across four I2S bus lines with two audio channels per bus. Channels 1 and 2 may be output on I2S1, channels 3 and 4 may be output on I2S2, channels 5 and 6 may be output on I2S3, and channels 7 and 8 may be output on channels 7 and 8. Haptics actuators may be divided into four or more daisy chains, where each I2S data bus is routed to the actuators 124 on the respective bus. Actuators 124 may be generally referred to as “control mechanisms” when used to control lighting or other effects. This I2S data may be synchronized with respect to I2S bit clock and word clock. I2S bit clock and data are converted to a differential signal and fed to each daisy chain output. In an example, the differential signal may be used to extend the number or distance of haptic actuators included in wearable device 108.

In an example, a subset of the audio channels is used for haptics data, and the remaining channels may be used for audio output. For instance, in a 7.1 surround sound signal, the left and right channels may be used for audio (e.g., fed to a digital to audio converter (DAC) and output to headphones on the HMD 106), while the remaining six channels may be used for haptics data. With two channels per bus, there may be three I2S buses used for daisy chaining haptics actuators. Various forms of multiplexing may be used to send haptic information, such as time-division or frequency-division haptic control multiplexing. In an example, an effect, intensity, and duration may be used to actuate multiple haptic actuators in a predefined sequence. Other configurations may also be used to divide the audio and haptics data across audio channels.

Since actuator blocks 124 are daisy chained, it is possible to add actuators to a daisy chain and upgrade the wearable device 108. Alternatively, a vendor may produce different versions of a wearable device without affecting existing connections. Once haptics actuators or other control mechanisms are added, only configuration information needs to be updated to define the association between control mechanism address and control mechanism location on the wearable device. In an example, a wearable device may include additional haptic feedback actuators or control mechanisms between pre-existing haptic feedback actuators of a wearable device. In another example, a wearable device may modified to include additional haptic feedback actuators or control mechanisms extending beyond the actuators or control mechanisms, such as farther down an arm sleeve or pant leg.

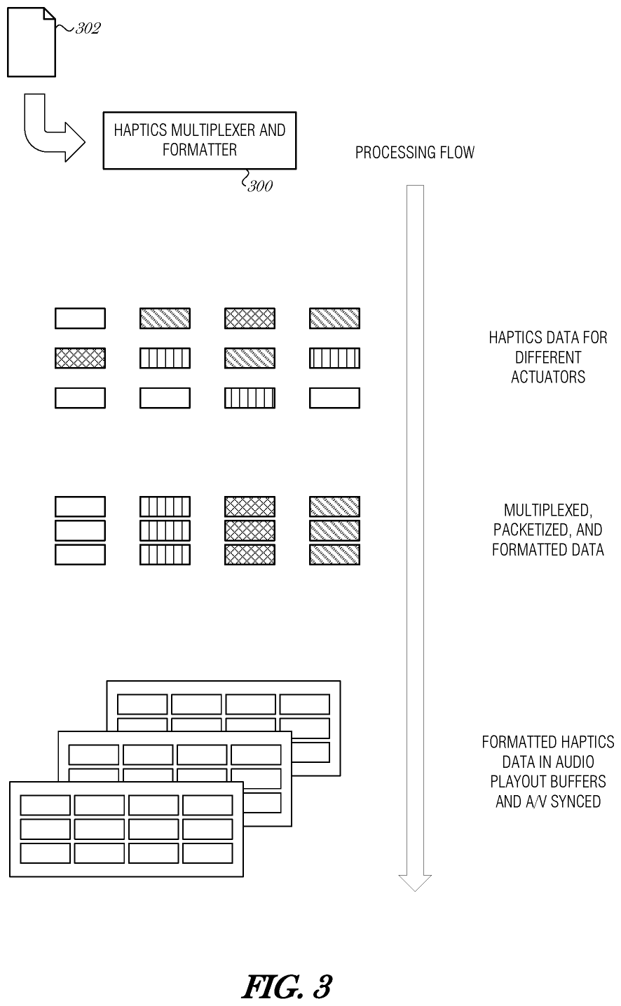

FIG. 3 is a block diagram illustrating a haptics multiplexer and formatter 300, according to an embodiment. The haptics multiplexer and formatter 300 may be implemented in software as a part of an application executing on a compute system (e.g., application 110 executing on compute system 102). Alternatively, the haptics multiplexer and formatter 300 may be middleware that is separate from the application and intercepts or receives video data, physics data, audio data, or other information from the application for which haptics are to be coordinated.

The haptics multiplexer and formatter 300 may access a configuration 302, which may be stored in a configuration file that is accessed on system startup, application startup, or the like. The configuration 302 includes a mapping between a haptic actuator location and a haptic actuator address. The location refers to the location on a wearable device and may be stored as a descriptive string, such as “left hand,” “right hand,” “upper chest,” “left shin,” or the like. The number and placement of haptics actuators may vary depending on the design of a wearable device, cost of a wearable device, use case of a wearable device, or other haptic configuration factors regarding the wearable device, user, regulator constraints, or the like.

Data received from the application by the haptics multiplexer and formatter 300 may include relative or absolute location data. For instance, a game engine in the application may track object collisions (e.g., bullets colliding with a user's avatar), and may track the collision location (e.g., gunshot to right forearm). The collision location information may be stored in a data packet and provided to a video frame renderer, for instance, to render a blood spray from the corresponding avatar limb. This collision information may be passed to the haptics multiplexer and formatter 300, which may process haptics data for different actuators, packetize and format the haptics data, and output the haptics frames in audio buffers that are synchronized with the video frame data.

While haptics actuators are discussed in FIG. 3, it is understood that general control mechanisms may be used, which may drive haptics, lights, or other effects using location and address mappings.

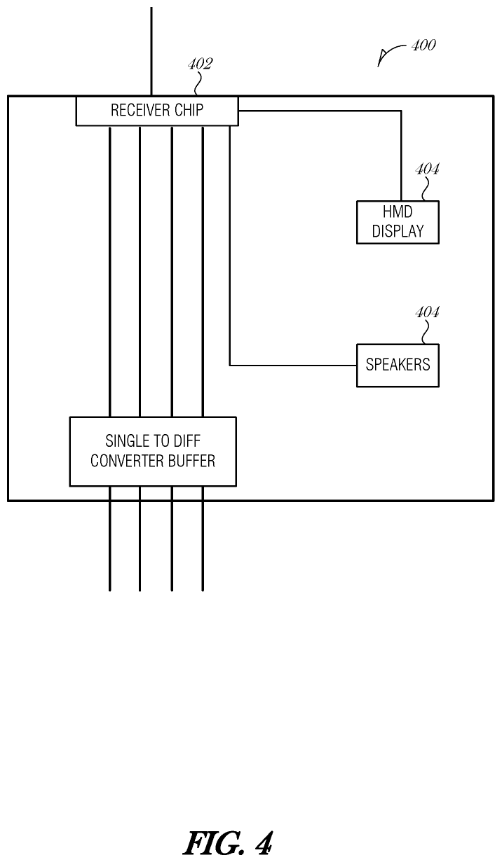

FIG. 4 is a block diagram illustrating a head-mounted display (HMD) 400, according to an embodiment. The HMD includes a receiver chip 402 that separate video data and audio data. The video data is used to drive one or more displays 404 on the HMD 400 (e.g., left and right display panel). The audio data is processed to determine which audio data frames are haptic data frames and which are audio data frames. Audio data frames are used to drive one or more resident speakers 406 on the HMD 400 or one or more external speakers.

The haptics data frames are passed through the appropriate bus as identified by the compute device. No inspection is required in HMD 400. In an example, the haptics multiplexer and formatter 300 ensures that the correct data is sent on I2S1/2/3/4 buses based on the location information of the actuators located on body. I2S lines are passed as is to daisy chains, where actuators inspect the frames to determine the destination address for each frame. The frame is transmitted on the appropriate bus (e.g., I2S line) that includes the addressable haptics actuator.

As described above, the haptics actuators may be divided among several buses, such as each bus running to a different zone on a haptic suit. I2S data may be formatted to synchronize with respect to an I2S bit clock and a word clock. I2S clock and data signals are converted to differential signals (e.g., to extend an effective physical signal transmission length) and fed to each daisy chain output. In an example, each I2S data channel can run up to ˜9 Mbps (max) in conventional HDMI. This channel throughput may increase with further HDMI development. As such, it easily carries multiplexed data for a large number of actuators, dependent on the frame size.

Again, here in FIG. 4, the description is not limited to haptics data frames, but may be extended to any type of control mechanism (e.g., lighting).

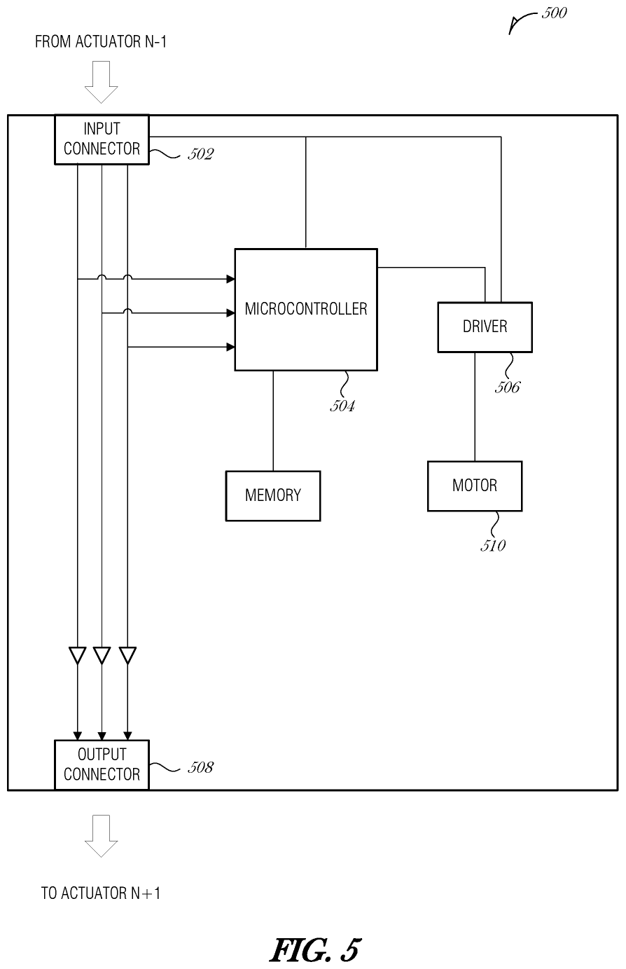

FIG. 5 is a block diagram of a haptics actuator 500, according to an embodiment. The haptics actuator 500 may be arranged in a daisy chain of other one or more haptics actuators (not shown). The haptics actuator 500 may receive haptics data frames at an input connection 502 from an upstream haptics actuator. Note that if the haptics actuator 500 is the first in line from the buffer, then it may receive the haptics data frames directly from the buffer in the HMD 400.

The haptics actuator 500 has an input connector 502, microcontroller 504, haptic driver 506, and output connector 508. Haptic driver 506 may be used to drive a motor 510, which may be a linear resonance actuator (LRA), eccentric rotating mass (ERM) motor, or the like. In an example, the haptics actuator 500 inputs three differential lines (e.g., I2S1, bit clock (BCLK), word clock (WCLK)). The input may include an I2S input and output, which may be included as an I2S bus or other bus protocol. In an example, the I2S input and output represent buffered input signals to drive haptics actuators downstream in the daisy chain.

Differential data is read off the lines by the microcontroller 504 and converted to single-ended (e.g., non-differential) output. The microcontroller 504 parses the data as it receives (e.g., sampled at BCLK and WCLK) and looks for a haptics actuator address in data stream. If it finds a match for its own address, then the haptics frame is extracted. The microcontroller 504 decodes the haptics frame and finds effect, intensity, and duration details and controls the haptics motor to produce the appropriate response.

The differential signals are amplified and output via output connector 508 to additional haptic actuators. Note that if this actuator is the last in the daisy chain, the signal lines may be terminated. As such, as each differential line is terminated at (e.g., connected to) each actuator, the signal at each actuator is replenished (e.g., amplified), buffered, and sent downstream. With this arrangement, a large number of haptics adapters may be connected in series while reducing or minimizing signal loading concerns.

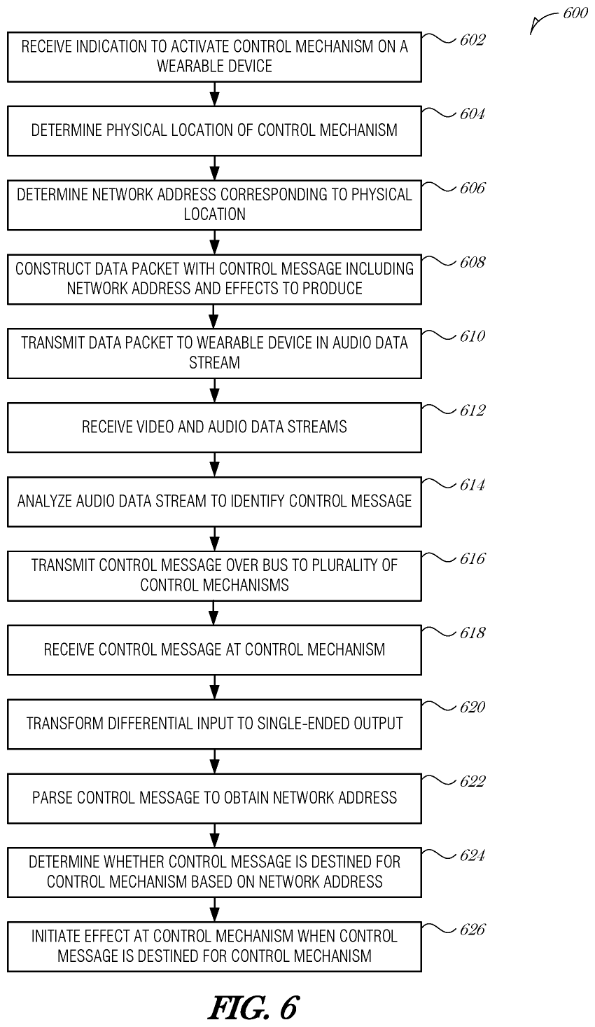

FIG. 6 is a flowchart illustrating a method 600 of synchronizing haptic actuators with displayed content, according to an embodiment. The method 600 begins operations at a computing system. At block 602, an indication to activate a control mechanism from among a plurality of control mechanisms on a wearable device connected to the system is received from an application executing on the computing system.

In an embodiment, the control mechanism is a haptics actuator. In a further embodiment, the wearable device includes a haptics suit. In a further embodiment, the details of the effect include a type of effect, an intensity of effect, or a duration of effect.

In an embodiment, the control mechanism is a light controller. In a further embodiment, the details of the effect include a color of light, an intensity of illumination, or a duration of illumination.

At block 604, a physical location of the control mechanism on the wearable device is determined. A configuration file or configuration database may be referenced to determine the physical location. This information may be preassembled by a user (e.g., an administrator, game designer, end user, etc.).

At 606, a network address corresponding to the physical location of the control mechanism is determined. The mapping between the network address and the physical location may be maintained in a configuration file, configuration database, or the like. The mapping may be stored with the references to the physical locations of the control mechanisms, or may be stored separately.

At 608, a data packet including a control message is constructed, the control message including the network address of the control mechanism and details of an effect that the control mechanism is to produce.

At 610, the data packet is transmitted to wearable device in an audio data stream. In an embodiment, transmitting the data packet includes transmitting the data packet using a high-definition multimedia interface (HDMI) protocol.

The method 600 continues operation at a head-mounted display (HMD) system. At 612, a video data stream and a time-correlated audio data stream is received. In an embodiment, the video data stream and the time-correlated audio data stream are contained in a high-definition multimedia interface (HMDI) message. In an embodiment, the method 600 includes transmitting the video data stream to a video processor in the HMD for output to a video display.

At 614, the audio data stream is analyzed to identify control messages in the audio data stream. This may be performed by packet inspection techniques and analyzing the preamble, mode, or other fields in the packetized audio data stream.

At 616, the control messages are transmitted over a bus to a plurality of control mechanisms. In an embodiment, transmitting the control messages over the bus includes separating the audio data stream into a plurality of channels, each channel associated with a serial bus that includes a plurality of control mechanisms. Then, a single to differential converter buffer is used to convert the audio data stream to a differential signal and a selected channel from the audio stream is identified. The differential signal is output over the serial bus corresponding to the selected channel. In a further embodiment, the serial bus is an Inter-IC Sound (I2S) bus.

The method 600 continues operation at a control mechanism. At 618, differential input and a clock input are received, where the differential input includes the control message.

At 620, the differential input is transformed to single-ended output, the single-ended output including the control message.

At 622, the control message is parsed to obtain the network address.

At 624, it is determined whether the control message is destined for the control mechanism based on the network address. A bitwise comparator may be used to determine whether the control message is addressed to the control mechanism.

At 626, an effect produced by the control mechanism is initiated based on the control message when the control message is destined for the control mechanism.

In an embodiment, the method 600 includes amplifying the differential input to produce an amplified differential signal and transmitting the amplified differential signal to a second control mechanism.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, such as modules, intellectual property (IP) blocks or cores, or mechanisms. Such logic or components may be hardware, software, or firmware communicatively coupled to one or more processors in order to carry out the operations described herein. Logic or components may be hardware modules (e.g., IP block), and as such may be considered tangible entities capable of performing specified operations and may be configured or arranged in a certain manner. In an example, circuits may be arranged (e.g., internally or with respect to external entities such as other circuits) in a specified manner as an IP block, IP core, system-on-chip (SOC), or the like.

In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

An IP block (also referred to as an IP core) is a reusable unit of logic, cell, or integrated circuit. An IP block may be used as a part of a field programmable gate array (FPGA), application-specific integrated circuit (ASIC), programmable logic device (PLD), system on a chip (SOC), or the like. It may be configured for a particular purpose, such as digital signal processing or image processing. Example IP cores include central processing unit (CPU) cores, integrated graphics, security, input/output (I/O) control, system agent, graphics processing unit (GPU), artificial intelligence, neural processors, image processing unit, communication interfaces, memory controller, peripheral device control, platform controller hub, or the like.

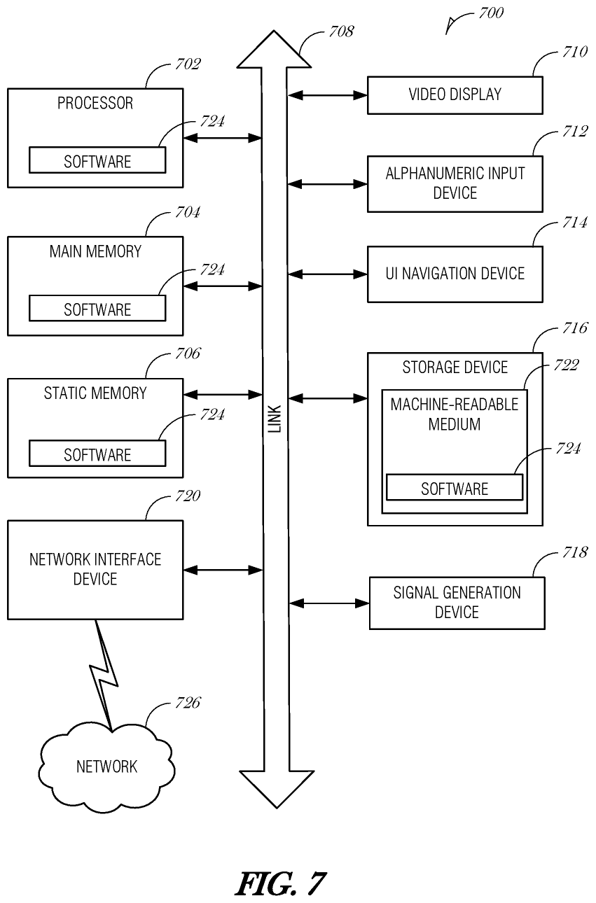

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, memory devices, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for synchronizing haptic actuators with displayed content comprising: a processor subsystem; and a non-transitory memory device comprising instructions, which when executed by the processor subsystem, cause the processor subsystem to: receive from an application executing on the system, an indication to activate a control mechanism from among a plurality of control mechanisms on a wearable device connected to the system; determine a physical location of the control mechanism on the wearable device; determine a network address corresponding to the physical location of the control mechanism; construct a data packet including the network address of the control mechanism and details of an effect that the control mechanism is to produce; and transmit the data packet to wearable device.

In Example 2, the subject matter of Example 1 includes, wherein the control mechanism is a haptics actuator.

In Example 3, the subject matter of Example 2 includes, wherein the wearable device comprises a haptics suit.

In Example 4, the subject matter of Examples 2-3 includes, wherein the details of the effect include a type of effect, an intensity of effect, or a duration of effect.

In Example 5, the subject matter of Examples 1-4 includes, wherein the control mechanism is a light controller.

In Example 6, the subject matter of Example 5 includes, wherein the details of the effect include a color of light, an intensity of illumination, or a duration of illumination.

In Example 7, the subject matter of Examples 1-6 includes, wherein to transmit the data packet, the processor subsystem is to transmit the data packet using a high-definition multimedia interface protocol.

Example 8 is a method for synchronizing haptic actuators with displayed content comprising: receiving from an application executing on a system, an indication to activate a control mechanism from among a plurality of control mechanisms on a wearable device connected to the system; determining a physical location of the control mechanism on the wearable device; determining a network address corresponding to the physical location of the control mechanism; constructing a data packet including the network address of the control mechanism and details of an effect that the control mechanism is to produce; and transmitting the data packet to wearable device.

In Example 9, the subject matter of Example 8 includes, wherein the control mechanism is a haptics actuator.

In Example 10, the subject matter of Example 9 includes, wherein the wearable device comprises a haptics suit.

In Example 11, the subject matter of Examples 9-10 includes, wherein the details of the effect include a type of effect, an intensity of effect, or a duration of effect.

In Example 12, the subject matter of Examples 8-11 includes, wherein the control mechanism is a light controller.

In Example 13, the subject matter of Example 12 includes, wherein the details of the effect include a color of light, an intensity of illumination, or a duration of illumination.

In Example 14, the subject matter of Examples 8-13 includes, wherein transmitting the data packet comprises transmitting the data packet using a high-definition multimedia interface protocol.

Example 15 is at least one machine-readable medium including instructions, which when executed by a machine, cause the machine to perform operations of any of the methods of Examples 8-14.

Example 16 is an apparatus comprising means for performing any of the methods of Examples 8-14.

Example 17 is an apparatus for synchronizing haptic actuators with displayed content comprising: means for receiving from an application executing on a system, an indication to activate a control mechanism from among a plurality of control mechanisms on a wearable device connected to the system; means for determining a physical location of the control mechanism on the wearable device; means for determining a network address corresponding to the physical location of the control mechanism; means for constructing a data packet including the network address of the control mechanism and details of an effect that the control mechanism is to produce; and means for transmitting the data packet to wearable device.

In Example 18, the subject matter of Example 17 includes, wherein the control mechanism is a haptics actuator.

In Example 19, the subject matter of Example 18 includes, wherein the wearable device comprises a haptics suit.

In Example 20, the subject matter of Examples 18-19 includes, wherein the details of the effect include a type of effect, an intensity of effect, or a duration of effect.

In Example 21, the subject matter of Examples 17-20 includes, wherein the control mechanism is a light controller.

In Example 22, the subject matter of Example 21 includes, wherein the details of the effect include a color of light, an intensity of illumination, or a duration of illumination.

In Example 23, the subject matter of Examples 17-22 includes, wherein the means for transmitting the data packet comprise means for transmitting the data packet using a high-definition multimedia interface protocol.

Example 24 is at least one machine-readable medium for synchronizing haptic actuators with displayed content including instructions, which when executed by a machine, cause the machine to perform operations comprising: receiving from an application executing on a system, an indication to activate a control mechanism from among a plurality of control mechanisms on a wearable device connected to the system; determining a physical location of the control mechanism on the wearable device; determining a network address corresponding to the physical location of the control mechanism; constructing a data packet including the network address of the control mechanism and details of an effect that the control mechanism is to produce; and transmitting the data packet to wearable device.

In Example 25, the subject matter of Example 24 includes, wherein the control mechanism is a haptics actuator.

In Example 26, the subject matter of Example 25 includes, wherein the wearable device comprises a haptics suit.

In Example 27, the subject matter of Examples 25-26 includes, wherein the details of the effect include a type of effect, an intensity of effect, or a duration of effect.

In Example 28, the subject matter of Examples 24-27 includes, wherein the control mechanism is a light controller.

In Example 29, the subject matter of Example 28 includes, wherein the details of the effect include a color of light, an intensity of illumination, or a duration of illumination.

In Example 30, the subject matter of Examples 24-29 includes, wherein the instructions for transmitting the data packet comprise instructions for transmitting the data packet using a high-definition multimedia interface protocol.

Example 31 is a head-mounted display system for synchronizing haptic actuators with displayed content comprising: a processor subsystem; and a non-transitory memory device comprising instructions, which when executed by the processor subsystem, cause the processor subsystem to: receive a video data stream and a time-correlated audio data stream; analyze the audio data stream to identify control messages in the audio data stream; and transmit the control messages over a bus to a plurality of control mechanisms, the plurality of control mechanisms to analyze the control messages and act on control messages that are addressed to a respective control mechanism of the plurality of control mechanisms.

In Example 32, the subject matter of Example 31 includes, instructions that cause the processor subsystem to transmit the video data stream to a video processor in the head-mounted display for output to a video display.

In Example 33, the subject matter of Examples 31-32 includes, wherein to transmit the control messages, the processor subsystem is to: separate the audio data stream into a plurality of channels, each channel associated with a serial bus that includes a plurality of control mechanisms; use a single to differential converter buffer to convert the audio data stream to a differential signal; identify a selected channel from the audio stream; and output the differential signal over the serial bus corresponding to the selected channel.

In Example 34, the subject matter of Example 33 includes, wherein the serial bus is an Inter-IC Sound (I2S) bus.

In Example 35, the subject matter of Examples 31-34 includes, wherein the video data stream and the time-correlated audio data stream are contained in a high-definition multimedia interface message.

Example 36 is a method for synchronizing haptic actuators with displayed content comprising: receiving, at a head-mounted display, a video data stream and a time-correlated audio data stream; analyzing the audio data stream to identify control messages in the audio data stream; and transmitting the control messages over a bus to a plurality of control mechanisms, the plurality of control mechanisms to analyze the control messages and act on control messages that are addressed to a respective control mechanism of the plurality of control mechanisms.

In Example 37, the subject matter of Example 36 includes, transmitting the video data stream to a video processor in the head-mounted display for output to a video display.

In Example 38, the subject matter of Examples 36-37 includes, wherein transmitting the control messages comprises: separating the audio data stream into a plurality of channels, each channel associated with a serial bus that includes a plurality of control mechanisms; using a single to differential converter buffer to convert the audio data stream to a differential signal; identifying a selected channel from the audio stream; and outputting the differential signal over the serial bus corresponding to the selected channel.

In Example 39, the subject matter of Example 38 includes, wherein the serial bus is an Inter-IC Sound (I2S) bus.

In Example 40, the subject matter of Examples 36-39 includes, wherein the video data stream and the time-correlated audio data stream are contained in a high-definition multimedia interface message.

Example 41 is at least one machine-readable medium including instructions, which when executed by a machine, cause the machine to perform operations of any of the methods of Examples 36-40.

Example 42 is an apparatus comprising means for performing any of the methods of Examples 36-40.

Example 43 is an apparatus for synchronizing haptic actuators with displayed content comprising: means for receiving, at a head-mounted display, a video data stream and a time-correlated audio data stream; means for analyzing the audio data stream to identify control messages in the audio data stream; and means for transmitting the control messages over a bus to a plurality of control mechanisms, the plurality of control mechanisms to analyze the control messages and act on control messages that are addressed to a respective control mechanism of the plurality of control mechanisms.

In Example 44, the subject matter of Example 43 includes, means for transmitting the video data stream to a video processor in the head-mounted display for output to a video display.

In Example 45, the subject matter of Examples 43-44 includes, wherein the means for transmitting the control messages comprise: means for separating the audio data stream into a plurality of channels, each channel associated with a serial bus that includes a plurality of control mechanisms; means for using a single to differential converter buffer to convert the audio data stream to a differential signal; means for identifying a selected channel from the audio stream; and means for outputting the differential signal over the serial bus corresponding to the selected channel.

In Example 46, the subject matter of Example 45 includes, wherein the serial bus is an Inter-IC Sound (I2S) bus.

In Example 47, the subject matter of Examples 43-46 includes, wherein the video data stream and the time-correlated audio data stream are contained in a high-definition multimedia interface message.

Example 48 is at least one machine-readable medium for synchronizing haptic actuators with displayed content including instructions, which when executed by a machine, cause the machine to perform operations comprising: receiving, at a head-mounted display, a video data stream and a time-correlated audio data stream; analyzing the audio data stream to identify control messages in the audio data stream; and transmitting the control messages over a bus to a plurality of control mechanisms, the plurality of control mechanisms to analyze the control messages and act on control messages that are addressed to a respective control mechanism of the plurality of control mechanisms.

In Example 49, the subject matter of Example 48 includes, instructions for transmitting the video data stream to a video processor in the head-mounted display for output to a video display.

In Example 50, the subject matter of Examples 48-49 includes, wherein the instructions for transmitting the control messages comprise instructions for: separating the audio data stream into a plurality of channels, each channel associated with a serial bus that includes a plurality of control mechanisms; using a single to differential converter buffer to convert the audio data stream to a differential signal; identifying a selected channel from the audio stream; and outputting the differential signal over the serial bus corresponding to the selected channel.

In Example 51, the subject matter of Example 50 includes, wherein the serial bus is an Inter-IC Sound (I2S) bus.

In Example 52, the subject matter of Examples 48-51 includes, wherein the video data stream and the time-correlated audio data stream are contained in a high-definition multimedia interface message.

Example 53 is a control mechanism for synchronizing haptic actuators with displayed content comprising: an input connector to receive differential input and a clock input, the differential input including a control message; a microprocessor to: transform the differential input to single-ended output, the single-ended output including the control message; parse the control message to obtain a network address; determine whether the control message is destined for the control mechanism based on the network address; and initiate an effect produced by the control mechanism, based on the control message when the control message is destined for the control mechanism.

In Example 54, the subject matter of Example 53 includes, wherein the control mechanism includes a haptics actuator.

In Example 55, the subject matter of Example 54 includes, wherein the control message includes a type, intensity, or duration of the effect to produce by the control mechanism.

In Example 56, the subject matter of Examples 53-55 includes, wherein the control mechanism includes a light controller.

In Example 57, the subject matter of Example 56 includes, wherein the control message includes a color, intensity, or duration of the effect to produce by the control mechanism.

In Example 58, the subject matter of Examples 53-57 includes, wherein the control mechanism includes a signal amplifier to amplify the differential input and produce an amplified differential signal, and an output connection to transmit the amplified differential signal to a second control mechanism.

In Example 59, the subject matter of Examples 53-58 includes, wherein the control message is packetized in a high-definition multimedia interface audio frame.

Example 60 is a method for synchronizing haptic actuators with displayed content comprising: receiving, at a control mechanism, differential input and a clock input, the differential input including a control message; transforming the differential input to single-ended output, the single-ended output including the control message; parsing the control message to obtain a network address; determining whether the control message is destined for the control mechanism based on the network address; and initiating an effect produced by the control mechanism, based on the control message when the control message is destined for the control mechanism.

In Example 61, the subject matter of Example 60 includes, wherein the control mechanism includes a haptics actuator.

In Example 62, the subject matter of Example 61 includes, wherein the control message includes a type, intensity, or duration of the effect to produce by the control mechanism.

In Example 63, the subject matter of Examples 60-62 includes, wherein the control mechanism includes a light controller.

In Example 64, the subject matter of Example 63 includes, wherein the control message includes a color, intensity, or duration of the effect to produce by the control mechanism.

In Example 65, the subject matter of Examples 60-64 includes, wherein the control mechanism includes a signal amplifier to amplify the differential input and produce an amplified differential signal, and an output connection to transmit the amplified differential signal to a second control mechanism.

In Example 66, the subject matter of Examples 60-65 includes, wherein the control message is packetized in a high-definition multimedia interface audio frame.

Example 67 is at least one machine-readable medium including instructions, which when executed by a machine, cause the machine to perform operations of any of the methods of Examples 60-66.

Example 68 is an apparatus comprising means for performing any of the methods of Examples 60-66.

Example 69 is an apparatus for synchronizing haptic actuators with displayed content comprising: means for receiving, at a control mechanism, differential input and a clock input, the differential input including a control message; means for transforming the differential input to single-ended output, the single-ended output including the control message; means for parsing the control message to obtain a network address; means for determining whether the control message is destined for the control mechanism based on the network address; and means for initiating an effect produced by the control mechanism, based on the control message when the control message is destined for the control mechanism.

In Example 70, the subject matter of Example 69 includes, wherein the control mechanism includes a haptics actuator.

In Example 71, the subject matter of Example 70 includes, wherein the control message includes a type, intensity, or duration of the effect to produce by the control mechanism.

In Example 72, the subject matter of Examples 69-71 includes, wherein the control mechanism includes a light controller.

In Example 73, the subject matter of Example 72 includes, wherein the control message includes a color, intensity, or duration of the effect to produce by the control mechanism.

In Example 74, the subject matter of Examples 69-73 includes, wherein the control mechanism includes a signal amplifier to amplify the differential input and produce an amplified differential signal, and an output connection to transmit the amplified differential signal to a second control mechanism.

In Example 75, the subject matter of Examples 69-74 includes, wherein the control message is packetized in a high-definition multimedia interface audio frame.

Example 76 is at least one machine-readable medium for synchronizing haptic actuators with displayed content including instructions, which when executed by a machine, cause the machine to perform operations comprising: receiving, at a control mechanism, differential input and a clock input, the differential input including a control message; transforming the differential input to single-ended output, the single-ended output including the control message; parsing the control message to obtain a network address; determining whether the control message is destined for the control mechanism based on the network address; and initiating an effect produced by the control mechanism, based on the control message when the control message is destined for the control mechanism.

In Example 77, the subject matter of Example 76 includes, wherein the control mechanism includes a haptics actuator.

In Example 78, the subject matter of Example 77 includes, wherein the control message includes a type, intensity, or duration of the effect to produce by the control mechanism.

In Example 79, the subject matter of Examples 76-78 includes, wherein the control mechanism includes a light controller.

In Example 80, the subject matter of Example 79 includes, wherein the control message includes a color, intensity, or duration of the effect to produce by the control mechanism.

In Example 81, the subject matter of Examples 76-80 includes, wherein the control mechanism includes a signal amplifier to amplify the differential input and produce an amplified differential signal, and an output connection to transmit the amplified differential signal to a second control mechanism.

In Example 82, the subject matter of Examples 76-81 includes, wherein the control message is packetized in a high-definition multimedia interface audio frame.

Example 83 is a method for synchronizing haptic actuators with displayed content comprising: at a computing system: receiving from an application executing on the computing system, an indication to activate a control mechanism from among a plurality of control mechanisms on a wearable device connected to the system; determining a physical location of the control mechanism on the wearable device; determining a network address corresponding to the physical location of the control mechanism; constructing a data packet including a control message, the control message including the network address of the control mechanism and details of an effect that the control mechanism is to produce; and transmitting the data packet to wearable device in an audio data stream; and at a head-mounted display (HMD) system: receiving a video data stream and a time-correlated audio data stream; analyzing the audio data stream to identify control messages in the audio data stream; and transmitting the control messages over a bus to a plurality of control mechanisms; and at the control mechanism on the bus: receive differential input and a clock input, the differential input including the control message; transforming the differential input to single-ended output, the single-ended output including the control message; parsing the control message to obtain the network address; determining whether the control message is destined for the control mechanism based on the network address; and initiating an effect produced by the control mechanism, based on the control message when the control message is destined for the control mechanism.

In Example 84, the subject matter of Example 83 includes, wherein the control mechanism is a haptics actuator.

In Example 85, the subject matter of Example 84 includes, wherein the wearable device comprises a haptics suit.

In Example 86, the subject matter of Example 85 includes, wherein the details of the effect include a type of effect, an intensity of effect, or a duration of effect.

In Example 87, the subject matter of Examples 83-86 includes, wherein the control mechanism is a light controller.

In Example 88, the subject matter of Example 87 includes, wherein the details of the effect include a color of light, an intensity of illumination, or a duration of illumination.

In Example 89, the subject matter of Examples 83-88 includes, transmitting the data packet comprises transmitting the data packet using a high-definition multimedia interface protocol.

In Example 90, the subject matter of Examples 83-89 includes, transmitting the video data stream to a video processor in the HMD for output to a video display.

In Example 91, the subject matter of Examples 83-90 includes, wherein transmitting the control messages over the bus comprises: separating the audio data stream into a plurality of channels, each channel associated with a serial bus that includes a plurality of control mechanisms; using a single to differential converter buffer to convert the audio data stream to a differential signal; identifying a selected channel from the audio stream; and outputting the differential signal over the serial bus corresponding to the selected channel.

In Example 92, the subject matter of Example 91 includes, wherein the serial bus is an Inter-IC Sound (I2S) bus.

In Example 93, the subject matter of Examples 83-92 includes, wherein the video data stream and the time-correlated audio data stream are contained in a high-definition multimedia interface message.

In Example 94, the subject matter of Examples 83-93 includes, amplifying the differential input to produce an amplified differential signal; and transmitting the amplified differential signal to a second control mechanism.

Example 95 is at least one machine-readable medium including instructions that, when executed by processing circuitry, cause the processing circuitry to perform operations to implement of any of Examples 1-94.

Example 96 is an apparatus comprising means to implement of any of Examples 1-94.

Example 97 is a system to implement of any of Examples 1-94.

Example 98 is a method to implement of any of Examples 1-94.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for synchronizing haptic actuators with displayed content comprising:
a processor subsystem; and
a non-transitory memory device comprising instructions, which when executed by the processor subsystem, cause the processor subsystem to:
receive from an application executing on the system, an indication to activate a control mechanism from among a plurality of control mechanisms on a wearable device connected to the system;
determine a physical location of the control mechanism on the wearable device;
determine a network address corresponding to the physical location of the control mechanism;
construct a data packet including the network address of the control mechanism and details of an effect that the control mechanism is to produce; and
transmit the data packet to wearable device.

2. The system of claim 1, wherein the control mechanism is a haptics actuator.

3. The system of claim 2, wherein the wearable device comprises a haptics suit.

4. The system of claim 2, wherein the details of the effect include a type of effect, an intensity of effect, or a duration of effect.

5. The system of claim 1, wherein the control mechanism is a light controller.

6. The system of claim 5, wherein the details of the effect include a color of light, an intensity of illumination, or a duration of illumination.

7. The system of claim 1, wherein to transmit the data packet, the processor subsystem is to transmit the data packet using a high-definition multimedia interface protocol.

8. A method for synchronizing haptic actuators with displayed content comprising:
receiving from an application executing on a system, an indication to activate a control mechanism from among a plurality of control mechanisms on a wearable device connected to the system;
determining a physical location of the control mechanism on the wearable device;
determining a network address corresponding to the physical location of the control mechanism;
constructing a data packet including the network address of the control mechanism and details of an effect that the control mechanism is to produce; and
transmitting the data packet to wearable device.

9. The method of claim 8, wherein the control mechanism is a haptics actuator.

10. The method of claim 9, wherein the wearable device comprises a haptics suit.

11. The method of claim 9, wherein the details of the effect include a type of effect, an intensity of effect, or a duration of effect.

12. The method of claim 8, wherein the control mechanism is a light controller.

13. The method of claim 12, wherein the details of the effect include a color of light, an intensity of illumination, or a duration of illumination.

14. The method of claim 8, wherein transmitting the data packet comprises transmitting the data packet using a high-definition multimedia interface protocol.

15. At least one machine-readable medium for synchronizing haptic actuators with displayed content including instructions, which when executed by a machine, cause the machine to perform operations comprising:
receiving from an application executing on a system, an indication to activate a control mechanism from among a plurality of control mechanisms on a wearable device connected to the system;
determining a physical location of the control mechanism on the wearable device;
determining a network address corresponding to the physical location of the control mechanism;
constructing a data packet including the network address of the control mechanism and details of an effect that the control mechanism is to produce; and
transmitting the data packet to wearable device.

16. The at least one machine-readable medium of claim 15, wherein the control mechanism is a haptics actuator.

17. The at least one machine-readable medium of claim 16, wherein the wearable device comprises a haptics suit.

18. The at least one machine-readable medium of claim 16, wherein the details of the effect include a type of effect, an intensity of effect, or a duration of effect.

19. The at least one machine-readable medium of claim 15, wherein the control mechanism is a light controller.

20. The at least one machine-readable medium of claim 19, wherein the details of the effect include a color of light, an intensity of illumination, or a duration of illumination.

21. The at least one machine-readable medium of claim 15, wherein the instructions for transmitting the data packet comprise instructions for transmitting the data packet using a high-definition multimedia interface protocol.
